(19) United States
(12) Patent Application Publication
(10) Pub. No.: US 2004/0046513 A1
(43) Pub. Date: Mar. 11, 2004

(54) Modified electronic ballast for a fluorescent lamp

(76) Inventor: Foo Onn Fah, Kowloon (CN)

Correspondence Address: DENNISON, SCHULTZ & DOUGHERTY, 1745 JEFFERSON DAVIS HIGHWAY, ARLINGTON, VA, 22202, US

(21) Appl. No.: 10/466,768

(22) PCT Filed: Jan. 31, 2002
(86) PCT No.: PCT/EP02/00989

(30) Foreign Application Priority Data
Feb. 2, 2001 (CN) 01 2 03074.0

(51) Int. Cl. H05B 37/02

(52) U.S. Cl. 315/291; 315/224; 315/209 R

(57) ABSTRACT

A modified electronic ballast for a fluorescent lamp comprises a filter rectifying circuit (10), a frequency converting circuit (20), lamp tubes (LA), starter (TP) and a first capacitor (C9-1). Both output ends of the frequency converting circuit (20) are each electrically connected to two filament electrodes at one side of the lamp tube (LA), two ends of the starter are each electrically connected to the two filaments electrodes at the other side of the lamp tube (LA), the first capacitor (C9-1) is connected to the two filament electrodes of the lamp tube (LA) in a manner of connection to the starter in parallel. The preheat starting for the tube (LA) can be performed in short-circuit means, and the hopping open-circuit can make the induction voltage high enough, allowing the lamp tube (LA) to have functions both of fair preheat starting and protection against abnormal working.

The present invention relates to a modified electronic ballast for a fluorescent lamp, and in particular, relates to a modified electronic ballast for a low-pressure mercury vapour discharging fluorescent lamp having multiple functions such as abnormal protection and pre-beating start.

A low pressure discharging fluorescent lamp includes straight tube fluorescent lamps, circular fluorescent lamps and compacted fluorescent lamps. These types of fluorescent lamps must work with ballasts matching thereto. In order to save energy, increase light emitting efficiency and minimize volume and weight, large quantities of electronic ballasts have been used in recent ten years. In addition to satisfying requirements for various electrical parameters of lamps, electronic ballasts must possess functions of protection under abnormal condition and preheating starting. The circuit design of the electronic ballasts now available on the market basically comprises three types: the first type using IC elements to achieve the objects. This electronic ballast has an advantageous performance, but also has its drawbacks, for example, the cost of the entire ballast is very high because IC elements are expensive and large quantities of matching elements are needed. As for the second type, the preheating and starting function of the lamp tube is accomplished by a circuit composed of thermistors and elements matching thereto, the abnormal protection function of the tube is achieved by a circuit composed of thyristor or triode and elements matching thereto. The drawbacks of this circuit are: too many elements and too expensive, especially, the protection scope of abnormal protection function is narrow and hence the reliability is low. As for the third type, the preheating and starting function of the lamp tube is accomplished by using the same circuit as the second type, but the abnormal protection function of the lamp tube is performed by a multi-time fuse, but such fuse is expensive, less reliable and the protection scope is narrow, especially when it is used for the lighting of two lamp tubes, the abnormal protection function Will fail. Therefore, all the electronic ballasts for a fluorescent lamps of the prior art have their drawbacks and improvements are needed. The object of this invention is to overcome the above mentioned defects and to provide a a modified electronic ballast for a fluorescent lamp, characterized in that by improving the circuit of an electronic ballast for a fluorescent lamp scientifically, economically and reasonably, an electronic ballast for a fluorescent lamp can reliably perform the function of abnormal protection and preheating start.

According to the one aspect of the invention, the technical means to achieve the above object are as follows: comprising a filter rectifying circuit, a frequency converting circuit including an inductance connected to one output of the frequency converting circuit, and a lamp tube, two output ends of said frequency converting circuit being each electrically connected to two filament electrodes at one side of said lamp tube, in addition, fiber comprising a starter and a first capacitor, two ends of said starter are each electrically connected to the two filament electrodes at another side of the lap tube, said first capacitor is connected to the two filament electrodes of the lamp tube in a manner of connection to the starter in parallel.

According to another aspect of the invention, the technical means to achieve the above objects are as follows: comprising a filter rectifying circuit, a frequency converting circuit including an inductance connected to one output of the frequency converting circuit, and a lamp tube, two output ends of said frequency converting circuit being each electrically connected to two filament electrodes at one side of said lamp tube, in addition, further comprising a starter and a first capacitor, wherein two leads of said capacitor are each connected to the two filament electrodes in a manner of connection to the two output ends of said frequency converting circuit.

Preferably the inductance, the first capacitor, the resistance of the electrodes and the reactance of the starter in its glow discharge state form a resonant circuit the frequency of which is close to the working frequency of the frequency converting circuit. The present invention farther teaches that the working frequency of the frequency converting Circuit is in the range of 30-50 KHz.

This invention, compared with the prior art, has following advantages: since the electronic ballast for the fluorescent lamp employs a circuit composed of lamp tubes, a starter and a first capacitor, the preheat starting of the lamp tube can be performed in short-circuit means, thus the current is steady and ample, and the hopping open-circuit makes the induction voltage high enough, the lamp tube starts steadily, and meanwhile, the abnormal protection performance for the lamp tube is also stable and the protection scope is wide. For example, when the external voltage fluctuates by 20%, or the tube parameter changes by 15%, the lamp tube can still be protected normally; when the circuit is applied to two lamp tubes for lighting, abnormal protection can also be performed normally. In addition, because the number of element used in the circuit is less than before, the cost, volume and weight can be decreased, and accordingly, the energy can be saved and light emitting efficiency can be increased, and also the stability and reliability for the lamp tube can be increased to a large extent.

This invention will be explained in detail via embodiments and in conjunction with drawings, in the drawings,

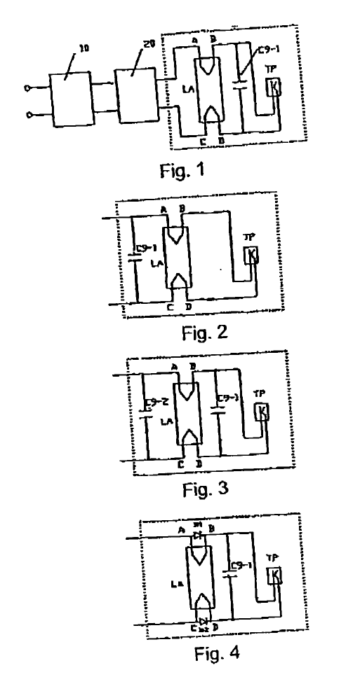

FIG. 1 is a circuit diagram showing a first embodiment of the invention;

FIG. 2 is a circuit diagram showing a second embodiment of the invention,

FIG. 3 is a circuit diagram showing a third embodiment of the invention;

FIG. 4 is a circuit diagram showing a fourth embodiment of the invention,

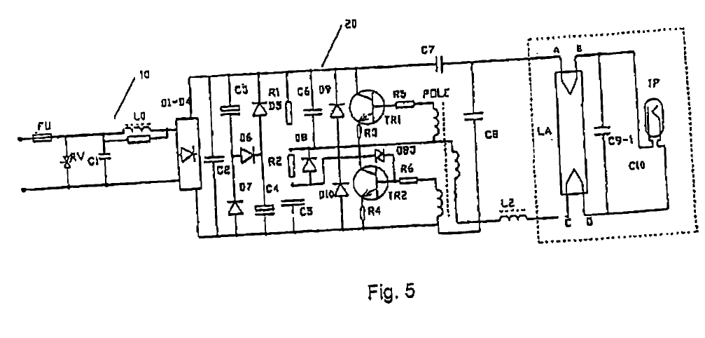

FIG. 5 is an application circuit diagram of a T8 tube 18W and 36W straight-tube fluorescent lamp according to embodiment 1 as shown in FIG. 1;

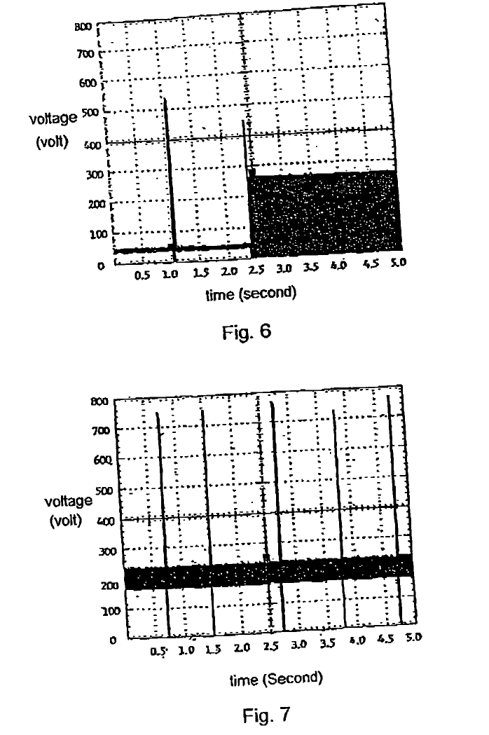

FIG. 6 is a voltage wave form diagram of the application circuit as shown in FIG. 5 measured during the preh at starling for the fluorescent lamp;

FIG. 7 is a voltage wave form diagram of the application circuit as shown in FIG. 5 measured in the abnormal protection for the fluorescent lamp.

Please refer to FIG. 1, it shows the main circuit for the first embodiment of this invention. This modified electronic ballast for a fluorescent lamp comprises a filter rectifying circuit 10, a frequency converter circuit 20, a lamp tube LA, a starter bulb provided for glow discharge or starter TP and a first capacitor C9-1, wherein lamp tube LA, starter TP and first capacitor C9-1 are surrounded by dot lines to show the newly-built circuit of this invention. It can be seen from the left block diagram of FIG. 1, filter rectifying circuit 10 is connected to frequency converter circuit 20 comprising an inductance L2 connected to one of its outputs, two output ends of said frequency converter circuit 20 are each connected to the two filament electrodes A, C at one side of the lamp tube LA, the two ends of the starter TP are each connected to the two filament electrodes B, D at the other side of the lamp tube LA, first capacitor C9-1 is connected to the two filament electrodes B, D in a manner of connection to starter TP in parallel.

Please refer to FIGS. 5-7, wherein FIG. 5 shows that T8 tube 16W and 36W straight tube fluorescent lamp is applied to the application circuit in the embodiment as shown in FIG. 1. In this application circuit, filter rectifying circuit 10 and frequency converter circuit 20 at the left side of the lamp tube are conventionally known circuits, wherein filter rectifying circuit 10 consists of a filter circuit composed of capacitor C1, inductor L0 and resistors, and a rectifier circuit composed of diodes D1-D4, frequency converter circuit 20 is mainly composed of a pair of push-pull transistors TR1 and TR2, a trigger diode DB3, a transformer POLE, an inductance or inductor L2 with magnet, a capacitor C8 and other diodes and capacitors. Two output ends of the frequency converter circuit (20) are each electrically connected to the two filament electrodes A, C at one side of lamp tube LA through inductor L2; at the right side of the tube, as described above, both ends of the starter TP are each connected to the two filament electrodes B, D at the other side of the lamp tube LA, and first capacitor C9-1 is connected to the two filament electrodes B, D in a manner of connection to starter TP in parallel. A resonant circuit is composed of inductance or inductor L2, capacitor C9-1, the resistances of the electrodes of the tube and the reactance of the starter TP which is a jumping bulb in its glow discharge state, the resonant frequency of which is close to the working frequency of the frequency converting circuit. The frequency of the frequency converting circuit is in the range of 30-50 KHz

The operation principles and functions of the above circuit according to this invention model when in use:

1) When the electronic ballast is connected to power supply, high frequency voltage will be applied on the two ends of starter TP and capacitor C9-1 through the two filaments of lamp tube LA, the starter will immediately glow discharge, the glow discharging current of starter TP serves to preheat the electrodes after flowing through the filaments of the tube; meanwhile, the current also flows through the starter TP, beating the bimetal moving plates in starter TP under the action of this current, and making it quickly move. Since the oscillation of the resonant circuit is very strong, a high current and a high voltage are created. Thus, in a very short time, the current makes the moving plates and fixed plates in the starter TP close, forming a short-circuit current, such current serves to continue or further preheat the electrodes of the tube. After another period of time, since the temperature of the moving plate and fixed plate in the starter TP gradually drops, after short-circuiting for about 0.8-1.5 seconds, the moving plate and the fixed plate are open-circuited, generating a transient induction high voltage on both ends of the lamp tube LA to breakdown the lamp tube for starting and entering into normal lighting state. This procedure accomplishes the function of preheat starting for the lamp tube LA.

2. When the lamp tube LA itself is working abnormally, for example, the lamp tube LA cannot start lighting normally due to its leakage or being in a bad circumstance, losing activity for the cathode or exhaustion of the phosphor powder, the lamp tube LA will be continually electrified and the electronic ballast will work continuously. For electronic ballast with no protection against abnormal working, due to large current in the lamp tube LA and the mismatch between the tube LA and the electronic ballast, the electronic ballast will get damaged very soon. The protection against abnormal working of the modified electronic ballast for a fluorescent lamp is performed as follows: after the lamp tube LA is electrified, the preheating is performed according to the above procedure, when the induction voltage produced after the preheating process cannot breakdown the lamp tube LA for starting due to the abnormality of the lamp tube, the starter TP will immediately glow discharge, and also becomes short-circuited. The capacitor C9-1 also becomes short-circuited. At this time, the difference between the resonant frequency of the resonant circuit and the working frequency of the frequency converting circuit is large. Therefore, the oscillation intensity of the resonant circuit decreases and the current decreases too. Thus the temperature rise of the transistors TR1, TR2 and capacitor C9-1 is not too high, and the elements are not damaged. The preheating process will be repeated. Thus the circuit win recycle continuously due to the repeating of this process. Since in such circulation, the short-circuit time of the starter TP is far greater than its open-circuit time, the current is higher when the starter is open circuited than in the closed state, so the average power consumed by the current is far less than the power for normal lighting, and the electronic ballast will not get damaged, thus accomplishing the function of abnormal protection of safety protection for the electronic ballast.

During the preheat starting of the lamp tube LA in the electronic ballast, the real voltage waveform measured on both ends of the lamp tube LA, preheating time of 1.4 seconds are shown in FIG. 6. When the lamp tube LA is under abnormal protection, the actual voltage waveform measured on both ends of the lamp tube LA are shown in FIG. 7. Preheating and starting are performed in recycling means, this time, the consumption power for 36W tube is 11 W, and 6W for 18W tube; after recycling for more than 400,000 times, the electronic ballast will remain undamaged.

Please refer to FIG. 2, which shows the circuit configuration for the second embodiment of this invention. In this embodiment, the circuit configuration of the electronic ballast for the fluorescent lamp is essentially identical to that of the first embodiment, except that both leads of said capacitor C9-1 are each connected to the two filament electrodes A, C of the lamp tube LA in a manner of connection to both ends of the frequency converting circuit 20.

Please refer to FIG. 3, which shows the circuit configuration for the third embodiment of this invention. In this embodiment, the circuit configuration of the electronic ballast for the fluorescent lamp further comprises a second capacitor C9-2 in addition to the circuit configuration for the first embodiment, both leads of said second capacitor C9-2 are each connected to the two filament electrodes A, C of the lamp tube LA in a manner of connection to both ends of the frequency converting circuit 20.

Please refer to FIG. 4, which shows the circuit configuration for the fourth embodiment of this invention. In his embodiment, the circuit configuration of the electronic ballast for the fluorescent lamp further comprises two shunt diodes D11 and D12 in addition to the circuit configuration for the first embodiment, two ends of diodes D11 and D12 are each positively connected with regard to the direction of current to the two ends A, B and C, D of each filament electrode for the lamp tube LA, on the contrary, two ends of diodes D11 and D12 can also be each negatively connected with regard to the direction of current to the two ends A, B and C, D of each filament electrode for the lamp tube LA (not shown in the Fig.), selection of the positive or negative connection for diodes D11 and D12 depends on whether the temperature of the heat point on the filament consists.

Apparently, the second to the fourth embodiments are the extension circuit of the first embodiment, for adjusting the preheating current of the filament in the lamp tube LA to obtain the most suitable preheating temperature.

An envelope oscillogram of the voltage peak values measured by a storage oscilloscope from the A and C points of the tube of the fluorescent lamp of the circuit of FIG. 5 during the process of preheating and starting is shown in FIG. 6. The lamp is a T8-18 W and 36 W straight tube,

An envelope oscillogram of the voltage peak values measured by a storage oscilloscope from the A and C points of the tube of the fluorescent lamp of the circuit of FIG. 5 during the protection against abnormal working is shown in FIG. 7.

In the modified electronic ballast of the fluorescent lamp for this invention, the lamp tube used comprises straight-shaped, circular and compact fluorescent lamps. In use, they all can achieve the effect of fair abnormal protection and preheat starting as mentioned above.

The above embodiments are provided only for the explanation to this invention, rather than limitation to it. Persons skilled in the art can make variations and alterations without departing from the spirit and scope of this invention. All identical technical solutions should fall within this scope and should not be limited by various claims.

1. A modified electronic ballast for a fluorescent lamp comprising a filter rectifying circuit (10), a frequency converting circuit (20) including an inductor (L2) connected to one output of the frequency converting circuit and a lamp tube (LA),
wherein
two output ends of said frequency converting circuit (20) are each electrically connected to two filament electrodes at one side of said lamp tube (LA); further comprising a starter (TP) and a first capacitors two ends of said starter (TP) are each electrically connected to the two filaments electrodes at the other side of the lamp tube (LA), said first capacitor is connected to the two filament electrodes of the lamp tube (LA), in a manner of connection to the starter (TP) in parallel

2. A modified electronic ballast for a fluorescent lamp comprising a filter rectifying circuit (10), a frequency converting circuit (20) including an inductor (L2) connected to one output of the frequency converting circuit and a lamp tube (LA),
wherein
two output ends of said frequency converting (20) circuit are each electrically connected to two filament electrodes at one side of said lamp tube (LA); further comprising a starter (TP) and a first capacitor (C9-1) wherein two leads of said first capacitor (C9-1) are each connected to the two filament electrodes in a manner of connection to the two output ends of said frequency converting circuit (20).

3. The modified electronic ballast for a fluorescent lamp according to claim 1 or 2,
wherein
the inductor (L2), the first capacitor (C9-1), the resistances of the electrodes and the reactance of the starter (TP) in its glow discharge state form a resonant circuit the resonant frequency of which is close to the working frequency of the frequency-converting circuit (20).

4. The modified electronic ballast for a fluorescent lamp according to claim 1, 2 or 3,
wherein
the working frequency of the frequency converting circuit is in the range of 30-50 Khz

5. The modified electronic ballast for a fluorescent lamp according to claim 1,
wherein
further comprising a second capacitor (C9-2), wherein the two leads of said second capacitor (C9-2) are each connected to the two ends (A, C) of the filament cathodes in a manner of connection to the two output ends of the frequency converting circuit (20).

6. The modified electronic ballast for a fluorescent lamp according to any of claims 1 to 5, her comprising two diodes (D11, D12),
wherein
two ends of said diodes are each positively connected to the two ends (AB; CD) of each filament cathode of the lamp tube (LA) with regard to the direction of current to the starter (TP).

7. The modified electronic ballast for a fluorescent lamp according to any of claims 1 to 5, comprising two Diodes,
wherein
the two ends of said diodes are each negatively connected to the two ends of each filament cathode of the lamp tube with regard to the current to the starter.
